(19) United States
(12) Patent Application Publication
(10) Pub. No.: US 2012/0276872 A1
(43) Pub. Date: Nov. 1, 2012

(54) METHOD AND APPARATUS FOR OVER-THE-AIR PROVISIONING

(75) Inventors: Daniel Knauth, Berlin (DE); Mehdi Farah, Malmo (SE)

(73) Assignee: Nokia Corporation, Espoo (FI)

(21) Appl. No.: 13/157,152

(22) Filed: Jun. 9, 2011

Related U.S. Application Data
(60) Provisional application No. 61/480,204, filed on Apr. 28, 2011.

(51) Int. Cl. H04W 4/00; H04W 12/06

(52) U.S. Cl. 455/411; 455/414.1

(57) ABSTRACT

An approach is presented for over-the-air service provisioning. A provisioning manager causes, at least in part, a generation of a request to provision one or more services at a device to operate over a data bearer of at least one communication network. The provisioning manager determines one or more access numbers associated with the one or more services, one or more service providers of the one or more services, or a combination thereof. The provisioning manager causes, at least in part, a transmission of the request based, at least in part, on the one or more access numbers. The one or more access numbers are preconfigured at the device for availability over a plurality of communication networks.

### RELATED APPLICATIONS

This application claims the benefit of the earlier filing date under 35 U.S.C. §119(e) of U.S. Provisional Application Ser. No. 61/480,204 filed Apr. 28, 2011, entitled “Method and Apparatus for Over-The-Air Provisioning,” the entirety of which is incorporated herein by reference.

### BACKGROUND

Service providers and device manufacturers (e.g., wireless, cellular, etc.) are continually challenged to deliver value and convenience to consumers by, for example, providing compelling network devices and services. One area of development of has been the provisioning of devices for access to one or more services available over networks. In developed countries and major cities, such provisioning processes have been initiated or controlled by a mobile network operator or other server-side component and executed via networks. In other traditional approaches, at least some network or server specific information is preconfigured in a device (e.g., customized provisioning information retrieved using, for instance, preconfigured uniform resource identifiers (URIs)). However, in some developing countries or rural areas where data networks are not widely available, such access to provisioning servers is limited to narrow bandwidth data bearers (such as SMS). In addition, when mobile devices and network access cards (e.g., SIM cards) are sold separately (such as in India), and users frequently change network access cards and/or the corresponding networks, a service provider cannot predict which communication network the mobile device will use. This makes it impossible to determine what provisioning information should be preconfigured on a mobile device in order to access a particular service. When mobile devices are not sold through a mobile network operator, there are no operator variants that are preconfigured with the operator's provisioning information. Accordingly, service providers and device manufacturers face significant challenges to facilitating the provisioning process in such environments.

### SOME EXAMPLE EMBODIMENTS

Therefore, there is a need for an approach for provisioning services at a mobile device to operate over a narrow bandwidth data bearer supported by a plurality of communication networks, particularly in cases where the device is not preconfigured with provisioning information about the services (e.g., when there is no subscription, prior relationship, and/or previously established policies between the device and the service provider).

According to one embodiment, a method comprises causing, at least in part, a generation of a request to provision one or more services at a device to operate over a data bearer of at least one communication network. The method also comprises determining one or more access numbers associated with the one or more services, one or more service providers of the one or more services, or a combination thereof. The method further comprises causing, at least in part, a transmission of the request based, at least in part, on the one or more access numbers. The one or more access numbers are preconfigured at the device for availability over a plurality of communication networks.

According to another embodiment, an apparatus comprises at least one processor, and at least one memory including computer program code for one or more programs, the at least one memory and the computer program code configured to, with the at least one processor, cause, at least in part, the apparatus to generate a request to provision one or more services at a device to operate over a data bearer of at least one communication network. The apparatus is also caused to determine one or more access numbers associated with the one or more services, one or more service providers of the one or more services, or a combination thereof. The apparatus is further caused to transmit the request based, at least in part, on the one or more access numbers. The one or more access numbers are preconfigured at the device for availability over a plurality of communication networks.

According to another embodiment, a computer-readable storage medium carries one or more sequences of one or more instructions which, when executed by one or more processors, cause, at least in part, an apparatus to generate a request to provision one or more services at a device to operate over a data bearer of at least one communication network. The apparatus is also caused to determine one or more access numbers associated with the one or more services, one or more service providers of the one or more services, or a combination thereof. The apparatus is further caused to transmit the request based, at least in part, on the one or more access numbers. The one or more access numbers are preconfigured at the device for availability over a plurality of communication networks.

According to another embodiment, an apparatus comprises means for causing, at least in part, a generation of a request to provision one or more services at a device to operate over a data bearer of at least one communication network. The apparatus also comprises means for determining one or more access numbers associated with the one or more services, one or more service providers of the one or more services, or a combination thereof. The apparatus further comprises means for causing, at least in part, a transmission of the request based, at least in part, on the one or more access numbers. The one or more access numbers are preconfigured at the device for availability over a plurality of communication networks.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between the service provider and the mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of over-the-air provisioning, according to one embodiment;

FIG. 2 is a diagram of the components of a provisioning manager, according to one embodiment;

FIGS. 3A-3B are flowcharts of processes for over-the-air provisioning, according to various embodiments;

FIG. 4 is a ladder diagram that illustrates a sequence of messages and processes for over-the-air provisioning, according to one embodiment;

FIG. 5 is a diagram of a provisioning request sent from a client device to a gateway, according to one embodiment;

FIGS. 6A-6D are diagrams of user interfaces utilized in the processes described with respect to FIGS. 3-5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for over-the-air provisioning are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “service provider” refers to an entity that provides services to other entities via networks. Examples of these services include Internet access, mobile phone services, web application hosting, etc. Although various embodiments are described with respect to mobile network operators, it is contemplated that an over-the-air provisioning mechanism described herein may be used with other service providers, such as Internet service providers (ISPs), cable companies, satellite TV, application service providers (ASP), managed service providers, etc.

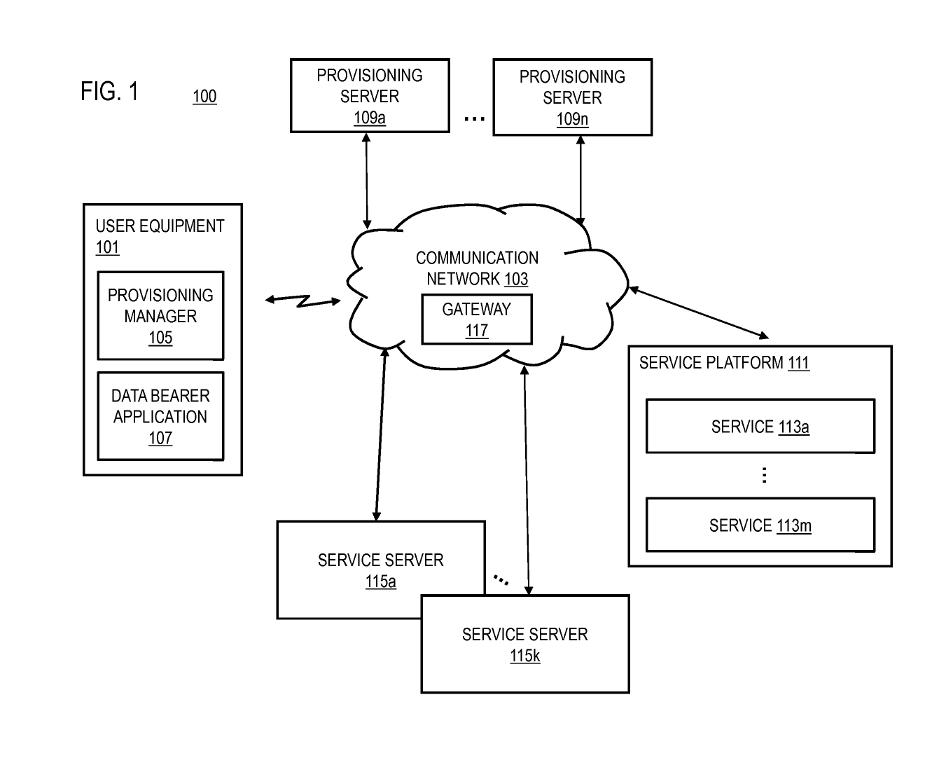

FIG. 1 is a diagram of a system capable of over-the-air provisioning, according to one embodiment. To access new services, such as GPRS, SMS, instant messaging, map services, etc., an existing client device of a mobile communication network needs to be provisioned with access settings to set up the new services associated with a service provider. In some cases, the service provider is not the existing mobile network operator that is associated with a network access card inserted in the client device. Historically, devices (e.g., those sold through operator channels) are provisioned through network initiated procedures (e.g., cellular-network initiated global system for mobile communications (GSM)/code division multiple access (CDMA) provisioning), through in-store provisioning, or through connecting to a host terminal (e.g., when provisioning or activating a smart phone through a personal computer (PC)). In other words, operators generally provision devices for services in their networks through network initiated procedures or otherwise use closed ecosystems with PC connectivity to configure the devices for services. However, in some scenarios, these provisioning approaches may not always be possible. For example, when smart phones or other network capable client devices or gadgets are purchased in the retail market (e.g., not supplied through operator channels), a retailer with no direct operator affiliation (e.g., an independent electronics shop) may not have access to network portals or representatives to perform the traditional provisioning. Moreover, users of such client devices may visit areas with limited or no access to data networks that typically support various access technologies (e.g., WiFi, Cognitive Radio, etc.) for services.

Another example where these provisioning approaches are not possible or otherwise not practical is where users have no access to personal computers. For example, the users live in rural areas and do not have access to personal computers to send emails or to browse the service provider's website to obtain service provisioning information. By way of example, GSM data access is not widely available in India and is used by about 10% of the population. Accordingly, a server in the Internet (e.g., a provisioning server) would not be able to connect to the devices via a computer and a data network to initiate a provisioning process to register for and access service.

When the mobile device has not been previously configured with service provisioning information, or if the preconfigured service provisioning information in the device is unavailable or limited, the mobile device would have no knowledge of the provisioning procedures for accessing a particular service.

To address this problem, a system 100 of FIG. 1 introduces an over-the-air (OTA) provisioning mechanism that is applicable to provisioning services for a variety of networks and/or service providers via a narrow bandwidth data bearer. Unlike e-mails and Internet browsers that require data network access, the OTA provisioning medium (e.g., SMS) can be sent out from a mobile phone from almost anywhere via a wireless communication network. The various embodiments of the OTA provisioning process described herein are related to provisioning services in a consumer mobile device. However, it is contemplated that the various embodiments described herein are also applicable to over-the-air provisioning of any device for service with any available network or service provider.

By way of example, a client device can be purchased or obtained in the retail market, and the user is free to choose a desired network access card with a plan associated with any network operator. The user can then subscribe/use a provider-specific service from the client device using the over-the-air provisioning process, although the service provider (e.g., Nokia) is independent from the current mobile network operator (e.g., Bharat Sanchar Nigam Limited, BSNL) that issued the SIM card. Moreover, the various embodiments of the over-the-air provisioning processes described herein enable the client device to request provisioning “on demand” or only when service access is requested by the client device. In this way, resources need not be used to provision access to services that the client device does not yet intend to access. By way of example, the OTA provisioning process transmits an OTA provisioning request from the client device to a provisioning server that sends provisioning configuration settings to the client device using SMS or WAP as supported by most mobile operating systems of a client device.

In one embodiment, the system 100 determines a client-based trigger (e.g., a service access attempt) for requesting provisioning of a client device for a service with a SIM card ID or network ID, used to obtain one or more access codes of a desired service. In one embodiment, in response to a trigger event, the system 100 generates a request to provision a service at a client device to operate over a data bearer of a least one communication network. The trigger event may be initiated by a service provider, the user device, or the user. For example, the user turns on the client device, and the user interface of the client device displays a preconfigured list of services of a service provider or device manufacturer, such as a Nokia SMS, a Nokia Map application, etc. In one embodiment, the OTA provisioning process leverages, for instance, the Open Mobile Alliance (OMA) Device Management (DM) standards and network specific protocols to transmit to the client device a configuration message including the access codes for the service. The access codes are then used by the client device to access the service.

In one embodiment, the system 100 detects through mechanisms native to the device technology (such as the SIM card, the GPS receiver, etc.) the existing mobile network at the current location to determine whether the existing mobile network is operated by the service provider or device manufacturer. If the determination is negative, the service needs to be provisioned via a preconfigured access mechanism, such as a general access code stored in the client device (e.g., a short code NOKIA or 66542) by the service provider or device manufacturer. The network detection can occur before, during, or after the trigger event and/or the rendering of the preconfigured service list.

For example, the system 100 detects that the existing mobile network is operated by, affiliated with, or has a roaming agreement with a local network operator (e.g., BSNL). If the existing mobile network is a WiFi network, a service set identifier (SSID) is periodically broadcasted in a beacon transmission. The system 100 can detect the SSID from the beacon transmission to determine the existing mobile network. Similar network specific mechanisms can be utilized in other types of networks. The system 100 then displays the preconfigured service list of the service provider or device manufacturer for the user to select. As such, the service provider or device manufacturer can compete with BSNL to offer similar and/or different services to the client device.

In other words, a service provisioning request can be generated based on a user-selected service through the user interface. In addition, or alternatively, the service provisioning request can be automatically generated or generated based on user-specified preferences (e.g., a preference to always use a service of the service provider or device manufacturer), with or without the user's intervention and/or knowledge. In one embodiment, after selecting a preconfigured service to provision, the client device generates a provisioning request. The request may, for instance, include, at least in part, information regarding the identification, capabilities, configuration, etc., of the existing mobile network. Optionally, the request may, for instance, include, at least in part, information regarding the identification, capabilities, configuration, etc., of the device (e.g., operating system, memory, processor, firmware, hardware capabilities, etc.).

In one embodiment, a network gateway is deployed to transmit the provisioning request to a provisioning server. In response, the provisioning server can send provisioning information and/or a registration invitation to the client device. The registration invitation provides, for instance, information on how to register and configure the service with the network for the services offered by the service provider.

In one embodiment, the provisioning server generates a configuration message to provision the service, for example through OMA DM and standard communication protocols such as an Internet Transport Layer Security (TLS) based network connection. The provisioning and/or registration invitation can be transmitted through other means such as hypertext transport protocol (HTTP), hypertext transport protocol secure (HTTPS), simple object access protocol (SOAP), universal plug and play device manager (UPnP DM), TR-069 remote management, extensible markup language (XML), JavaScript, JavaScript object notation (JSON), and the like.

In addition, or alternatively, the provisioning server can create and store the requested provisioning information. When there are data networks available, the provisioning server can send the location of the provisioning information (e.g., as a URI or URN), which can be used by the client device to fetch the provisioning information. In another embodiment, during the provisioning process, the system 100 can invoke another process in the device based, at least in part, on information and/or commands provided in the received provisioning information. For example, the provisioning server can include in the provisioning information an access code to a service server and an “Exec” command to start an application of a narrow bandwidth data bearer at the client device and direct the application to send out a service request using the data bearer to the service server.

In one embodiment, the user may be requested to provide user-specific information (e.g., name, address, service level, payment, etc.) to facilitate the provisioning process in order to register the user with the provisioning server and obtain provisioning information via the provisioning request. After entering the registration information, the provisioning server continues the provisioning process to send provisioning information (e.g., configuration settings or access codes for the service to the client device).

When there is no data network available, the provisioning server can send the provisioning information to the client device using a narrow bandwidth data bearer of the wireless communication network. The client device can then process the provisioning information to complete the provisioning process to gain access to the service.

By way of example, the configuration message can include, at least in part, one or more other access numbers, one or more settings, or a combination thereof that are associated with the service, a service bearer supported by the existing mobile network, or a combination thereof. The other access numbers/codes may be in a format of: (area code)-NOK-(service code). Each of the access codes correspond to a bundle of services associated with the selected service. In one embodiment, the cost of using the other access codes is lower than cost of using the short code NOKIA or 66542, whether it is paid by the service provider (i.e., toll-free) or the user (i.e., premium service). In another embodiment, the short code is configured into the phone software of region and/or country specific variants (e.g., Indian variants) during variant creation by the service provider or device manufacturer. By way of example, the short code is stored in the installation support module (ISM) settings of the client device.

After receiving the configuration message, the client device uses the other access numbers and/or settings to communicate with the provisioning server and/or a service server by sending out a service request for the service and optional registration information. In one embodiment, a verification process can be performed at the client device to ensure that the configuration message is directed to the client device. In another embodiment, the client device communicates with an authentication server before the initiating the service request (e.g., the client device can validate a root certificate of the provisioning or service server for security) to ensure the provisioning server is the real server as it represented itself.

The service request may, for instance, include, at least in part, the selected service, and information on the identification, financial information, preference, etc., of the user and information on the plan of the network access card (e.g., identification of the mobile network and/or its operator, access rights and restrictions, the available balance, etc.). With the information, the service provider can register the user with the service, and charge for the selected service directly or via the mobile network operator (under an existing fee splitting agreement, etc.). By way of example, the service request is sent to a new access code (20-665-1212) using an SMS message for information regarding a point of interest (e.g., the Bizmotel, Pune, India) for its address and contact information. The STD code (i.e., area code) for Pune in India is 20. The service server then returns the information of “1234 Mumbai Pune Highway, Opp. Big Bazaar, India, tel: 20-555-1234” using an SMS message.

SMS text messaging is increasingly vulnerable to snooping, spoofing, and interception multiply. In one embodiment, the service request is encrypted since it contains confidential user information. In another embodiment, when accepting a transaction (e.g., 100 shares of stock) or an order for a service/product (e.g., a round-trip airline ticket to Europe), the service server encrypts a randomly-generated password and sends the encrypted password via an SMS message to the client device. The client device has to decrypt the encrypted password and then include the randomly-generated password in an SMS message to approve the transaction or order, and then sends the SMS message back to the service server. As such, users can use their cell phones to authenticate their transactions or orders through the service using SMS messaging.

Using a narrow bandwidth data bearer, the system 100 can simplify and reduce the resource burden associated with provisioning various devices when provisioning processes. This is especially desirable where data networks are not possible, not practical, or otherwise not selected. In particular, provisioning processes for client devices (e.g., smart phones, etc.) with different access technologies is simplified relative to traditional network operator originated provisioning via data networks, such as PC-hosted provisioning. The various embodiments described bypass the PC or intermediary store to reduce resources associated with maintaining a PC-assisted or store-assisted provisioning process.

As shown in FIG. 1, the system 100 comprises at least one user equipment (UE) 101 (e.g., a client device) with connectivity to an existing communication network 103. As shown, the UE 101 includes a provisioning manager 105 to facilitate over-the-air provisioning as discussed with respect to the various embodiments described herein. To support the over-the-air provisioning process, the provisioning manager 105 may interact with a data bearer application 107 to facilitate the over-the-air provisioning process.

In this example, the provisioning manager 105 and/or the UE 101 also have connectivity to the respective provisioning servers 109a-109n (also collectively referred to as provisioning servers 109) of the communication network 103. In one embodiment, the connectivity of the provisioning servers 109 can occur through the communication network 103 using, for instance, OMA DM and TLS protocols.

In one embodiment, one or more services 113a-113m are provided via a service platform 111. In another embodiment, each service is provided via one or more service servers 115a-115k over the communication network 103.

In one embodiment, the source of the provisioning information provided by the provisioning servers 109 may be the service platform 111, the one or more services 113a-113m of the service platform 111, the one or more service servers 115a-115k, and/or other services available over the communication network 103. In another embodiment, the provisioning information is provided by the provisioning servers 109 via a gateway 117. The gateway 117 may be controlled by the operator of the communication network 103, or the operator of a provisioning server 109, or a gateway provider/aggregator. When the gateway 117 is controlled by one of the operators, the usage fee will be split between the operators based upon their bilateral agreement. When the gateway 117 is controlled by an aggregator, multiple agreements exist among the aggregator with operators to exchange two-way communication traffic. The aggregator controls over the message delivery and yet has no visibility to the users, since messages are delivered in the operator's message service center.

For example, a service 113a may obtain provisioning or registration data (e.g., notification messages or media content) from a service server 115a to deliver the obtained data to the provisioning servers 109, the provisioning manager 105, the data bearer application 107, and/or the UE 101 via the gateway 117.

In one embodiment, each of the services 113a-113m, for instance, may provide different content and/or different types of services (e.g., a map service, a social networking service, a messaging service, a music service, etc.) that may be independently or collectively provisioned according to the various embodiments described herein. In another embodiment, access to the communication network 103 and/or one or more of the services 113a-113m may be provided with a different quality of service (e.g., guaranteed throughput) based on the service level agreement made during the provisioning process.

By way of example, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), WiFi HotSpots, wireless LAN (WLAN), Bluetooth®, Internet Protocol (IP) data casting, satellite, mobile ad-hoc network (MANET), cognitive radio, Television White Spaces, and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

Communication is facilitated between the UE 101, the communication network 103, the provisioning servers 109, the service servers 115, the gateway 117, and other components of the system 100 using well known, new or still developing protocols. In this context, a protocol includes a set of rules defining how the network nodes within the communication network 103 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the provisioning manager 105 and the provisioning servers 109 (and/or the service servers 115) interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

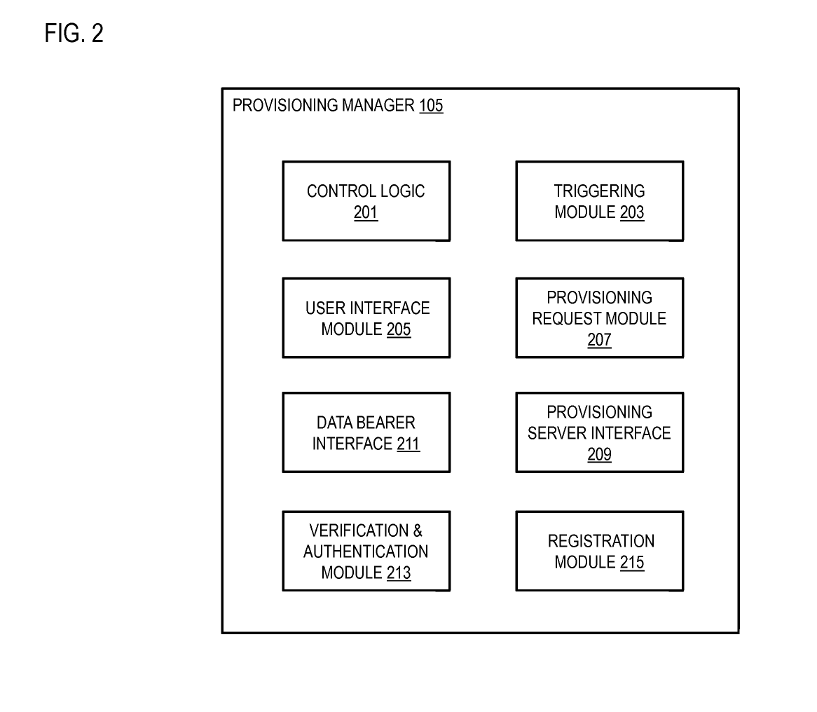

FIG. 2 is a diagram of the components of a provisioning manager 105, according to one embodiment. By way of example, the provisioning manager 105 includes one or more components for over-the-air provisioning. It is contemplated that the functions of these components may be combined in one or more components or performed by other components of equivalent functionality. In this embodiment, the provisioning manager 105 includes at least a control logic 201 which executes at least one algorithm for performing functions of the provisioning manager 105. For example, the control logic 201 interacts with a triggering module 203 to determine one or more triggering events for initiating a provisioning request to one or more provisioning servers 109. In one embodiment, the triggering module 203 can interact with the user interface module 205 to present a list of services 113 that are available for provisioning.

By way of example, the triggering module 203 can interact with the wireless radios or interfaces of the UE 101 to detect a first time use of the device, an initialization of the device, an execution of at least one client application of a selected service, and at least one change in an identifier of a SIM card, an identification module, or the communication network 103. In some embodiments, the first time use of the device or the initialization of the device can be determined based on an attempted access to an available communication network 103. In another embodiment, the UE 101 attempts to connect to a map service for which it has not been provisioned, the triggering module 203 can interpret the connection attempt as a provisioning triggering event.

On detecting a triggering event, the triggering module 203 (e.g., acting on the UE 101 client device) interacts with the provisioning request module 207 to generate a request for provisioning of a service offered by a server provider different from the operator of the communication network 103. In one embodiment, the request includes information regarding the identity, characteristics, capabilities, etc. of the network 103 to indicate specific provisioning requirements or parameters to access a desired service via the network 103. In another embodiment, the request includes information regarding the identity, characteristics, capabilities, etc. of the UE 101 to indicate specific provisioning requirements or parameters for the UE 101.

The provisioning server interface 209 then attempts to transmit the over-the-air provisioning request to the provisioning server 109. As previously noted, the transmission can be done using a narrow bandwidth data bearer, such as SMS. For example, the provisioning server interface 209 is allowed to send an SMS message via the communication network 103 for the purposes of initiating a service provisioning process.

It is contemplated that the provisioning server interface 209 may also use any other communication protocol or communication channel supported by the existing communication network 103 to communicate with the provisioning server 109. In one embodiment, the UE 101 uses other data bears (such as voice calls, audio message, etc.) supported by the network 103 to communicate with the provisioning server 109. For example, the provisioning request module 207 can convert or encapsulate the provisioning request into a voice call or message for the provisioning server interface 209 to send to the provisioning server 109. Additionally, any existing text-to-speech (TTS) algorithms can be used. The voice call or message can be decoded by the provisioning server 109 and does not need to be human apprehensible.

The provisioning server 109 can then recognize or extract the provisioning request from the voice call or message, parse the content data of the provisioning request, and retrieve the provisioning information for the selected service. The provisioning server 109 can then convert the provisioning information into a configuration voice call or message and send it to the UE 101. The UE 101 can then recognize the provisioning information in the configuration message, parse the provisioning information, and use the provisioning information to access the service.

After obtaining the provisioning information, the verification and authentication module 213 can attempt to verify whether the configuration message is addressed to the UE 101 by comparing the SIM card ID and/or the device ID extracted from the configuration message with those stored in the UE 101. If verification is successful, the verification and authentication module 213 notifies the provisioning request module 207 to initiate transmission of a service request to the service server 115. The service request can be transmitted over the service provision channel (e.g., SMS, voice call, etc.) established through the provisioning server interface 209. The provisioning request module 207 can then interact with the data bearer interface 211 to include the service request using a data bearer to send it to the service server 115.

In one embedment, the verification and authentication module 213 also attempts to authenticate the provisioning server 109 to ensure that the provisioning server 109 is authorized to accept provisioning requests and provide provisioning information for the desired service. In another embodiment, the authentication may include verifying security or authentication certificates associated with the server 109. It is contemplated that any authentication process can be used to verify the identity of the provisioning server 109. If authentication is successful, the verification and authentication module 213 notifies the provisioning request module 207 to initiate transmission of a service request over the service provision channel established through the provisioning server interface 209.

The provisioning request module 207 can then interact with the data bearer interface 211 to provide the service request to a data bearer to send it to the service server 115 and/or the provisioning server 109. In response, the provisioning request module 207 receives the service from the service server 115 and/or additional provisioning information (e.g., registration notification) from the provisioning server 109.

The provisioning request module 207 can then interact with the user interface module 205 to present all or a portion of the network provisioning and/or the service provisioning information in, for instance, a web application of the UE 101. In addition, or alternatively, it is contemplated that the provisioning may also be presented at any other application (e.g., a client application) or process executing on the UE 101. By way of example, the network/service provisioning information presented at the web application may include a description of the selected service offered by the service provider and/or the network 103 operated by the existing network operator, service agreements, service plans, payment information, account information, etc. associated with the selected service and/or the network 103. The service provisioning information presented at the web application may include a description of the services offered by the service provider (e.g., Nokia), service agreements, service plans, payment information, account information, etc. associated with the selected service (e.g., map services).

In one embodiment, the user can also make selections of the various service options via the data bearer application 107. Based on responses collected from, for instance, the data bearer application 107, the registration module 215 exchanges registration information with the provisioning server 109 to complete the over-the-air provisioning process and to gain access to the services.

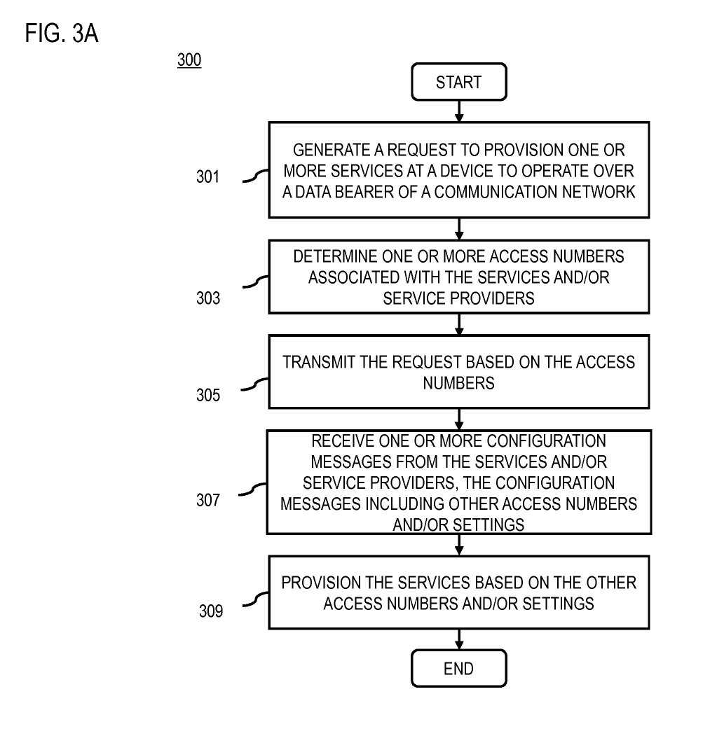

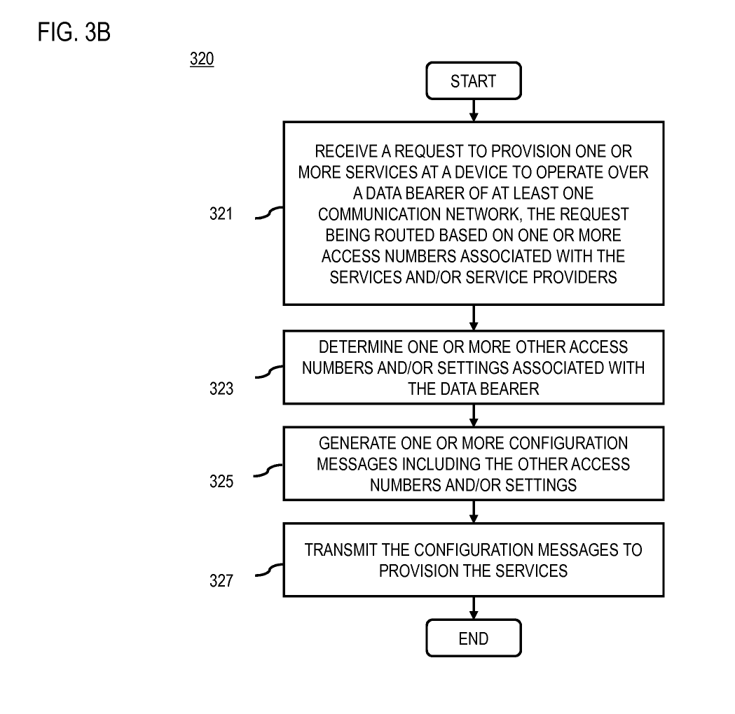

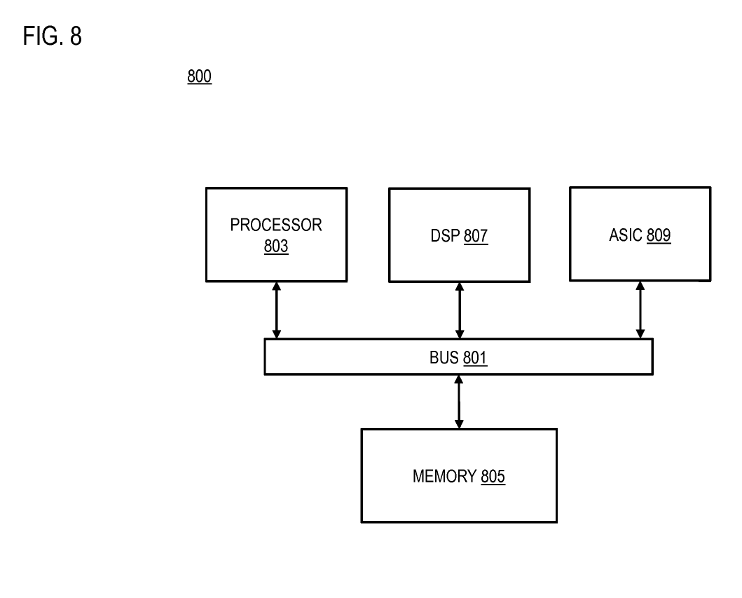

FIG. 3A is a flowchart of a process 300 for over-the-air provisioning, according to one embodiment. In one embodiment, the provisioning manager 105 performs the process 300 and is implemented in, for instance, a chip set including a processor and a memory as shown in FIG. 8. In step 301, the provisioning manager 105 causes, at least in part, generation of a request to provision one or more services at a device (e.g., a UE 101) to operate over a data bearer (e.g., SMS) of at least one communication network 103. In one embodiment, the network is a data network including, at least in part, a cellular network, a local area network, a wireless local area network, a proprietary packet-switched network, or a combination thereof.

In one embodiment, the request is triggered by, at least in part, an attempt by the UE 101 to access the service. By way of example, the attempt can be initiated by selecting from a list of available services through a user interface of the UE 101. If the list of services is retrieved from a SIM card, they are supported by the existing network operator such that the provisioning manager 105 can retrieve fixed dialing numbers (FDN) and/or service dialing numbers (SDN) to access the selected service. The specifications for SIM cards are described in GSM 11.11. Beside FDN and SDN, SIM cards store an integrated circuit card identifier (ICCID), international mobile subscriber identity (IMSI), authentication key (Ki), local area identity (LAI), and operator-specific emergency number, short message service center (SMSC) number, service provider name (SPN), advice-of-charge parameters, value added service (VAS) applications, etc.

If the list of services is preconfigured in UE 101 by a device manufacturer (e.g., Nokia), the SIM card issued by an regional or country-specific (e.g., Indian) network operator does not include prior information related to a provisioning of these services. The provisioning information for these services (e.g., access codes in terms of SMS, etc.) varies depending upon the existing communication network 103 and cannot be prefigured in the UE 101 by the device manufacturer. By way of example, there are over thirty communication network operators in India, and even more virtual network operators (VNO), such that it is impossible to preconfigure all provisioning information for all networks and/or network operators. In this case, the device manufacturer prefigures in the UE 101 one or more access numbers (e.g., a short code NOKIA or 66542) associated with the services (e.g., map services) offered by the device manufacturer to Indian users. Beside short codes, the access codes can be long access codes or phone numbers such as (country code)-(area code)-NOK-0020.

In step 303, the provisioning manager 105 determines the one or more access numbers associated with the one or more services, one or more service providers of the one or more services, or a combination thereof. By way of example, different services correspond to respective access codes. The local access number for map services in Pune is 20-NOK-0010, and the local access number for weather service in Pune is 20-NOK-0020, etc. Within the map services, there are sub numbers that correspond to various sub services: 20-NOK-0011 for the UE 101's current location, 20-NOK-0012 for the address and contact number of a point of interest, 20-NOK-0013 for the locations and distances of one or more nearby gas stations, 20-NOK-0014 for the locations and distances of one or more nearby restaurants, 20-NOK-0015 for the locations and distances of one or more nearby drug stores and hospitals, 20-NOK-0016 for the locations and distances of one or more nearby banks, etc.

In step 305, the provisioning manager 105 causes, at least in part, transmission of the request based, at least in part, on the one or more access numbers. The one or more access numbers are preconfigured in the UE 101 for availability over a plurality of communication networks.

In another embodiment, rather than triggering the provisioning request based on a user selected service, the provisioning manager 105 automatically sends out the request when the UE 101 is turned on or when the SIM card is detected. In these cases, the request may be sent out before the communication network 103 offers the similar services (e.g., map services) at the UE 101. In this case, the user may be exposed to the services offered by the device manufacturer earlier than those of the network operator.

In yet another embodiment, the provisioning manager 105 sends out the provisioning request upon an execution of at least one client application of the one or more services. By way of example, the provisioning manager 105 sends out the provisioning request when the user selects an icon presented on the user interface when the UE 101 is turned on, or when executing a client application (e.g., calculator, notepad, ring-tone, logo, business card, V-Calendar, V-Card, etc.) of the one or more services offered by the device manufacturer, or even when executing a client application (e.g., SMS, map services, etc.) of the one or more services of the existing network operator.

In yet another embodiment, the provisioning manager 105 sends out the provisioning request when at least one change in an identifier (e.g., of the current network operator, a client application, a service, etc.), an identification module (e.g., the SIM card, etc.), or the at least one communication network (e.g., roaming to a different network owned by the same or different operator) occurs.

In step 307, the provisioning manager 105 receives one or more configuration messages from the one or more services, the one or more service providers, or a combination thereof. The one or more configuration messages include at least in part one or more other access numbers, one or more settings, or a combination thereof associated with the data bearer.

In one embodiment, the provisioning information includes, at least in part, one or more other access codes and a command (e.g., an OMA DM Exec command to launch a data bearer application 107 to access the service).

In step 309, the provisioning manager 105 causes, at least in part, a provisioning of the one or more services based, at least in part, on the one or more other access numbers, the one or more settings, or a combination thereof. By way of example, the provisioning manager 105 causes, at least in part, directing of a data bearer application 107 (e.g., SMS) executing at the UE 101 to send, for example, an SMS message to the service server 115 accessible via, for example, 20-NOK-0012 for service information (e.g., the address and contact number of a specified restaurant).

FIG. 3B is a flowchart of a process 320 for over-the-air provisioning, according to one embodiment. In one embodiment, the provisioning server 109 performs the process 320 and is implemented in, for instance, a chip set including a processor and a memory as shown in FIG. 8. In step 321, the provisioning server 109 receives (from the UE 101 or the gateway 117) a request to provision one or more services at the UE 101 to operate over a data bearer of at least one communication network 103. The request is routed based, at least in part, on one or more access numbers associated with the one or more services, one or more service providers of the one or more services, or a combination thereof. The one or more access numbers are preconfigured at the device for availability over a plurality of communication networks (e.g., in India).

In step 323, the provisioning server 109 determines the one or more other access numbers, the one or more settings, or a combination thereof based, at least in part, on one or more functions of the one or more services. In another embodiment, the provisioning information may include registration information for access the service.

In step 325, the provisioning server 109 causes, at least in part, a generation of one or more configuration messages to provision the one or more services. The one or more configuration messages include, at least in part, one or more other access numbers, one or more settings, or a combination thereof associated with the data bearer. The generation of the one or more configuration messages is based, at least in part, on one or more device management protocols.

In step 327, the provisioning server 109 causes, at least in part, a transmission of the one or more configuration messages to provision the one or more services.

In yet another embodiment, it is contemplated that the provisioning manager 105 and/or the provisioning server 109 may not be able to complete the provisioning process and registration in one session. For example, the provisioning request is sent in a SMS message thus subject to the limitation of 160 characters. In this case, the provisioning manager 105 can later send a service request with the registration information or any other information to the provisioning server 109. In one embodiment, the provisioning server 109 facilitates registration of the UE 101 across a plurality of services and/or service servers 115, such that the user only needs to register once.

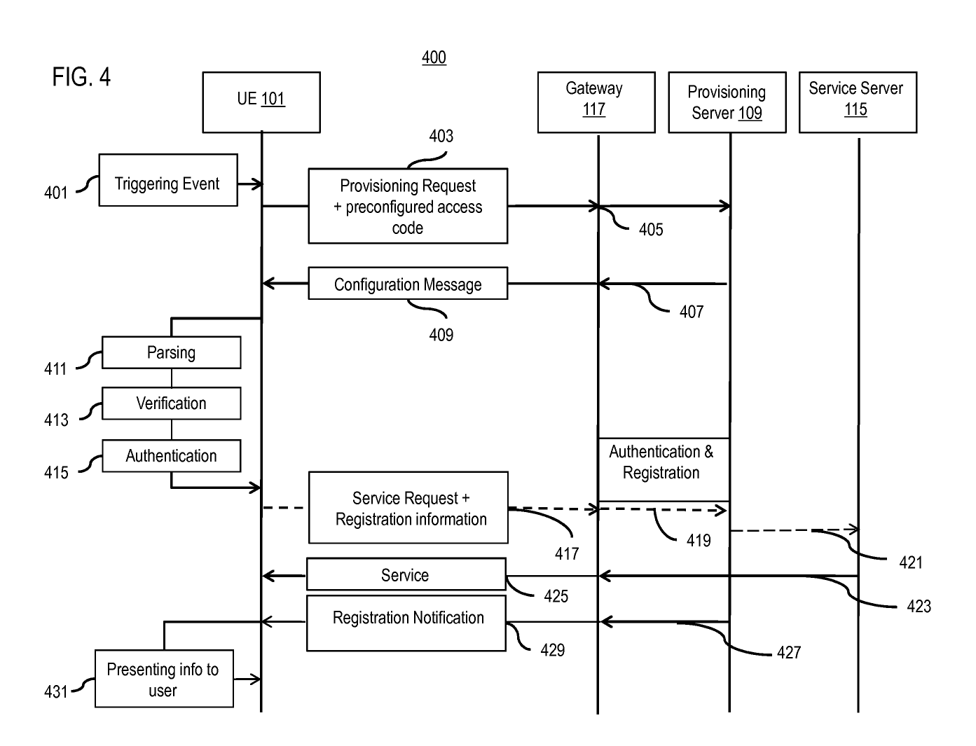

FIG. 4 is a ladder diagram that illustrates a process 400 that includes a sequence of messages and processes for over-the-air provisioning, according to one embodiment. FIG. 4 describes various embodiments of an over-the-air provisioning mechanism based on, for example, SMS and OMA DM, as the mechanisms for provisioning services. The process 400 includes a device 101 (e.g., a UE 101). In addition, the process 400 includes a gateway 117 that connects the UE 101 in a communication network 103 (e.g., a WiFi network) to a provisioning server 109 and a service server 115 associated with a service provider. Although the example of FIG. 4 is described with respect to provisioning in a wireless network, various embodiments of the over-the-air provisioning process 400 of FIG. 4 can be applied to other network provisioning scenarios including a WiFi network, home network, etc.

At step 401, a triggering event occurs as a result of the UE 101 trying to access an existing network 103 or a service. For example, this can be a result of the user manually selecting from one of the available services through a UI of the UE 101.

In one embodiment, the provisioning request generating processing includes, at least in part, retrieval information about the characteristics, capabilities, etc. of the network and/or the device. This information is then included in the provisioning request. In another embodiment, the provisioning manager 105 determines to include metadata in the provisioning request. By way of example, the metadata provides, at least in part, an identifier of the network 103, an identifier of the SIM card, an identifier of the UE 101, etc. The metadata may also be specified in a standardized format that is, for instance, known to both the provisioning manager 105 and the provisioning server 109.

In step 403, the provisioning request message is sent from the UE 101 to the gateway 117 using a short code (e.g., Nokia) in a SMS MAP MO-operation of the Short Message Service-Point to Point (SMS-PP) as defined in GSM recommendation 03.40. Short codes usually only work within one country, rather than internationally. The SMS message payload length is limited by the constraints of the signaling protocol to precisely 140 octets (140 octets=140*8 bits=1120 bits). Routing data and other metadata adds to the payload size. The SMS message may be sent through the short message peer-to-peer (SMPP) protocol, http protocol, etc.

In step 405, the gateway 117 extracts some of the content of the provisioning request to authenticate the UE 101 and verify if the UE 101 has subscribed to use the interested data bearer, e.g., SMS, within the network 103. By way of example, the gateway 117 uses an operator ID, a username, a password, and a PIN to authenticate the user, and uses a security token to verify that the UE 101 is authorized to use one or more services at the gateway 117.

After authenticating and verifying the UE 101, the gateway 117 directs all or a part of the content of the provisioning request to the provisioning server 109, typically using an IP protocol such as HTTP, SMPP or external machine interface (EMI). By way of example, the gateway 117 sends an IMSI of the SIM card, an operator ID, a network code, a country code, a local area code, a device ID, etc. (extracted from the provisioning request) to the provisioning server 109. The device manufacturer may be charged by the gateway operator and/or network operator for the processing of such provisioning requests. Nevertheless, the device manufacturer can later charge the user for rendering services, such as sending a new ringtone.

In step 407, the provisioning server 109 uses the operator ID, the network code, the country code, and local area code to retrieve one or more local access codes corresponding to the selected service and/or service server 115 available to the UE 101 at that local area (e.g., Pune, India). The provisioning server 109 then generates configuration data including at least the access codes, the IMSI of the SIM card, and the device ID. Optionally, the configuration data includes the device manufacturer ID, a key, etc.

The provisioning server 109 then transmits the configuration data to the gateway 117 using the IP protocol, such as HTTP, SMPP or EMI. The gateway 117 uses the configuration data to authenticate the provisioning server 109 and verify if the provisioning server 109 has contracted to use the interested data bearer, e.g., WAP push. By way of example, the gateway 117 uses the device manufacturer ID and the key to authenticate the provisioning server 109 and verify that the provisioning server 109 has contracted to use one or more services at the gateway 117, such as WAP push.

After authenticating and verifying the provisioning server 109, the gateway 117 encapsulates all or a part of the configuration data into a configuration message, and transmits the configuration message in a WAP push to the UE 101 in Step 409. Wireless Application Protocol (WAP) is an open international standard that includes a protocol suite allowing the interoperability of WAP equipment and software with many different network technologies, thus allowing the building of a single platform for competing network technologies such as GSM and CDMA networks. A WAP push is encoded with a link to a WAP address that allows WAP content to be pushed to the UE 101 with minimum user intervention. By way of example, the configuration message includes at least the access codes, the IMSI of the SIM card, the device ID, and the key.

In another embodiment, the generation of the one or more configuration messages is based, at least in part, on one or more device management protocols (e.g., OMA DM 1.3). At step 409, the gateway 117 initiates a DM session with the configuration message using, for instance, OMA DM protocols. By way of example, a Generic Alert is included in configuration message to inform the UE 101 that the configuration message is for a new service and access codes. More specifically, the Generic Alert is indicated by specifying the “Alert Type” in the DM Generic Alert included in the configuration message (e.g., the Alert Type carries information identifying the purpose of the session).

For example, in a wireless network, a Generic Alert can be sent in the configuration message with Alert Type “org.wirelessalliance.hs20.provisioning.mapservice” indicating that the UE 101 wishes to be provisioned for the map service. The WAP push carries an “Insert” command to set the value of “AccessCode” node in the DM tree. The value of this node is the new access code to which the UE 101 should use for sending out a service request. In addition to the Insert command, the WAP push also carries a DM “Exec” command. The Exec command is specified to be executed on the “AccessCode.” This would result in the UE 101 storing the access code in the internal database of the UE 101.

The gateway 117 then directs the configuration message to the UE 101 via data bearers such as SMS, USSD, GPRS, UMTS packet-radio service, or PPP on top of a circuit-switched data connection.

In step 411, the UE 101 parses from the configuration message at least the access codes, the IMSI of the SIM card, the device ID, and the key. In step 413, the UE 101 causes, at least in part, a comparison of the original IMSI of the SIM card with the IMSI associated with the one or more configuration messages, to verify that the configuration message is directed to the UE 101. If the two IMSIs are the same, the process continues to step 415. If the two IMSIs are different, the over-the-air provisioning process ends.

In step 415, the UE 101 authenticates the gateway 117, the provisioning server 109, or a combination thereof based, at least in part, on the key. After the verification and authentication, the UE 101 causes, at least in part, a caching of the configuration message at an internal memory or database of the UE 101. The over-the-air provisioning process thus is completed. In one embodiment the internal memory is an installation support module (ISM). During the over-the-air provisioning process, the authentication steps are optional.

The cached configuration message can be used for responding to one or more subsequent provisioning requests. In one embodiment, the device compares the IMSI of a newly inserted SIM card with the stored IMSIs to see if the newly inserted SIM card is a new SIM card. If the IMSI has already stored in the UE 101, the UE 101 retrieves the corresponding configuration message for access services offered by the UE 101 manufacturer without going via the processes 300 and 320. If the IMSI is not available in the UE 101, the UE 101 retrieves the corresponding network operator ID of the new SIM card and compares it against the network operator IDs in its internal database to see if the new SIM card is issued by a new or prior network operator. If the new SIM card is issued by a prior network operator, the UE 101 retrieves the corresponding configuration message for access services offered by the device manufacturer without going via the processes 300 and 320. If the new SIM card is issued by a new network operator, the UE 101 proceeds with the processes 300 and 320 to obtain a new configuration message.

In step 417, the UE 101 generates a service request and transmits the service request using the access codes (e.g., 20-NOK-0016) extracted from the configuration message to access the service, e.g., the locations and distances of one or more nearby banks. By way of example, the service request is sent over the same data bearer (e.g., SMS) as the provisioning request.

Optionally, the service request includes registration information. In one embodiment, the registration data includes, at least in part, identity information of the client device, identity information of a user of the client device, a selection of a rate plan, account information, payment information, or a combination thereof. In one embodiment, the registration data includes personal identify of the device or user, a selection of a rate plan, a subscriber's contact information, payment method (e.g., credit card), and the like. In another embodiment, the registration information is provided, at least in part, as one or more web-based standards (e.g., HTTP, HTTPS, JSON, JavaScript, XML, OMA DM managed objects (MOs), etc.). In another embedment, the registration information is included in the provisioning request, and the UE 101 is provisioned and registered with the device manufacturer in the same session.

After receiving the service request, the gateway 117 extracts from the service request the operator ID, the username, the password, and the PIN to authenticate the UE 101, and uses the token to verify that the UE 101 is authorized to use services at the gateway 117. In step 419, the gateway 117 sends the registration information extracted form the service request to the provisioning server 109.

In step 421, the gateway 117 sends to the service server 115 service input data, such as a query for a museum's operation hours. In step 423, the service server 115 retrieves information of the museum's operation hours based upon the user input of the museum name and country, and then transmits the service data to the gateway 117 using the IP protocol, such as HTTP, SMPP or EMI.

In step 425, the gateway 117 uses the service data to authenticate the service server 115 and verify if the service server 115 has contracted to use the interested data bearer, e.g., SMS. By way of example, the gateway 117 uses the UE 101 manufacturer ID and the key to authenticate the service server 115, and verify that the service server 115 has contracted to use one or more services at the gateway 117. The gateway 117 then transmits the service data in an SMS to the UE 101.

In step 427, the gateway 117 uses data included in the registration notification to authenticate the provisioning server 109 and verify that the provisioning server 109 has contracted to use the interested data bearer, e.g., SMS. By way of example, the gateway 117 uses the UE 101 manufacturer ID and the key to authenticate the provisioning server 109, and verify that the provisioning server 109 has contracted to use one or more services at the gateway 117.

In step 429, after authenticating and verifying the provisioning server 109, the gateway 117 encapsulates all or a part of the registration notification into a notification message, and transmits the notification message in an SMS to the UE 101. It is contemplated that the system 100 may use any method for indicating the end of the service/registration session depending on, for instance, the operating system platform, browser, or application. In step 431, the UE 101 then presents the registration notification to the user.

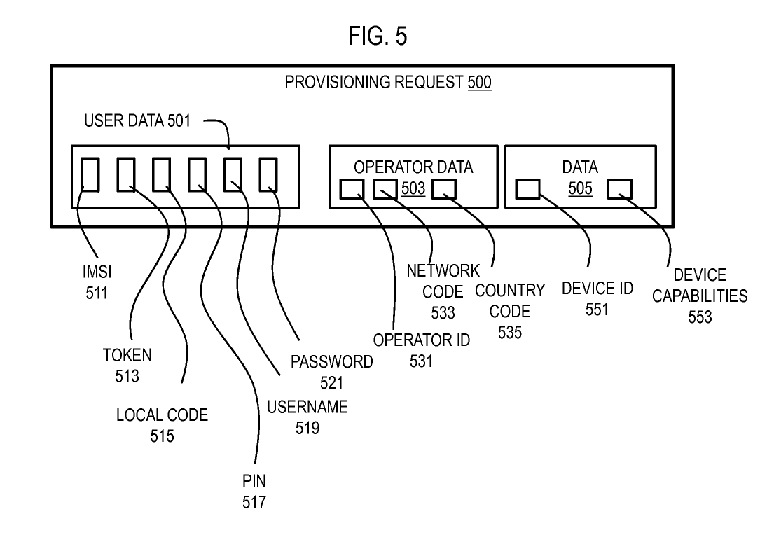

FIG. 5 is a diagram of a provisioning request 500 sent from the UE 101 to the gateway 117, according to one embodiment. The provisioning request includes a user data field 501, an operator data field 503, and optionally a UE data field 505.

The user data field 501 includes one or more of an IMSI field 511, a token field 513, a local code field 515, a personal identification number (PIN) field 517, a username field 519, and a password field 521.

The IMSI field 511 holds the IMSI stored on the SIM. The token field 513 holds data that indicates a token. The token is assigned by a single sign-on (SSO) module and indicates authorization to use at least one service at the gateway provider for a specified time.

The local code field 515 holds data that indicates a cell ID. The PIN field 517 holds data that indicates a personal identification number (PIN) supplied by the user; and, as data in the first three fields, is assigned during initial registration of a user with the network operator.

The username field 519 holds data that indicates a username used for authentication by some operators. Similarly, the password field 521 holds data that indicates a password used with the username for authentication by some operators.

The operator data field 503 includes one or more of an operator ID field 531, a network code 533, and a country code field 535. The operator ID field 531 holds data that uniquely indicates a particular operator, at least within a particular value for the country code field 535. The network code 533 holds data that uniquely indicates a network where the UE 101 is currently located to receive one or more network services. The country code field 535 holds data that uniquely indicates a country where the operator is registered to provide one or more network services. Thus, in some embodiments, the operator data field 503 further comprises a country identifier and an operator identifier. The country identifier indicates a country where the operator provides a service for user equipments. The operator identifier uniquely identifies the operator within the country.

The UE data field 505 includes one or more of a device identification field 551, and a device capability field 553. The device identification field 551 holds data that uniquely and globally indicates a particular device. The device capability field 553 holds capability data of the particular device (e.g., operating system, memory, processor, firmware, hardware capabilities, etc.).

Although data messages and fields are depicted in FIG. 5 as integral blocks arranged in a particular order for purposes of illustration, in other embodiments, one or more messages or fields, or portions thereof are arranged in a different order or one or more other fields are included, or the message is changed in some combination of ways. For example, in some embodiments, the UE data field 505 is omitted to shorten the provisioning request.

A service request sent from the UE 101 to the service server 115, according to one embodiment, includes the user data field 501, the operator data field 503, and a service input data field. The service input data field holds data used as input for the service, such as a contacts list or other user content to be backed up at a backup and restore service. For embodiments in which the selected service is authentication, the service input data field is omitted and one or more fields in the user data field 501 constitute input data for the service.

In some embodiments, the service request with certain fields is sent between the UE 101 and an authentication server. In some embodiments, the service request with the same or different fields is sent from the UE 101 to the gateway 117 or the provisioning server 109, or the service server 115.

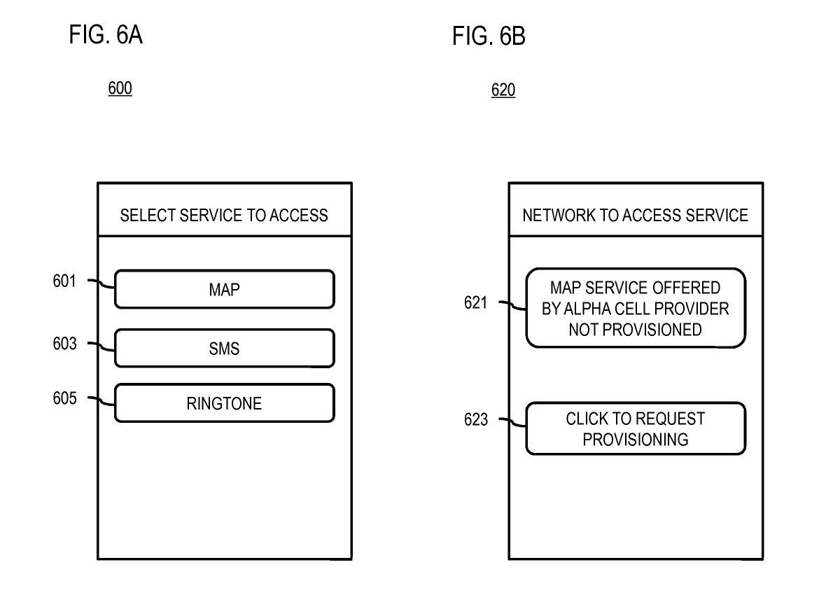

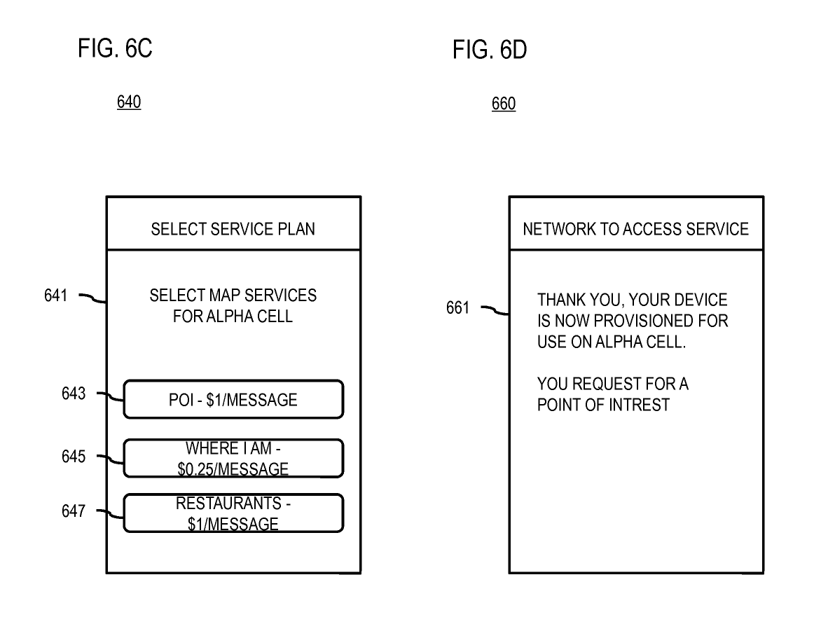

FIGS. 6A-6D are diagrams of user interfaces utilized in the processes described with respect to FIGS. 3-5, according to various embodiments. FIG. 6A depicts a user interface (UI) 600 that provides a list of services available to a UE 101 that is presenting or otherwise associated with the UI 600. As shown, the available services include Map 601, SMS 603, and Ringtone 605. In this example, the user selects to access Map service 601.

The provisioning manager 105 detects the attempt to access Map service 601 and determines that the Map service 601 has not been provisioned for the UE 101. Accordingly, a UI 620 of FIG. 6B is presented to provide an alert 621 that the Map service 601 offered by the Alpha Cell Provider has not been provisioned and to provide an option 623 to provision the Map service 601 according to various embodiments of the over-the-air provisioning process described herein.

In this example, the user selects to provision the Map service 601. In response, the provisioning manager 105 initiates the over-the-air provisioning process and receives provisioning information from the corresponding provisioning server 109. This provisioning information is presented in the UI 640 of FIG. 6C. In one embodiment, the UI 640 is presented in a data bearer application 107 executing at the UE 101. As shown, the UI 640 presents provisioning information including map services selection information. More specifically, the UI 640 presents an alert 641 to instruct the user to select one of the map services for provisioning and provides options 643, 645 and 647 for three different map services.

As shown, the user selects to provision map service 601 with the network 103 according to POI service 643. In response, the provisioning manager 105 sends out a provisioning request to a short code, receives respective local access codes for different map service options 643, 645 and 647, presents a UI 660 of FIG. 6D to display a confirmation message 661 that the over-the-air provisioning process is complete. The confirmation message 661 also displays confirmation of the selected service. In the over-the-air provisioning process, the access codes used by the system 100 are used without showing them to the user.

The processes described herein for over-the-air provisioning may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

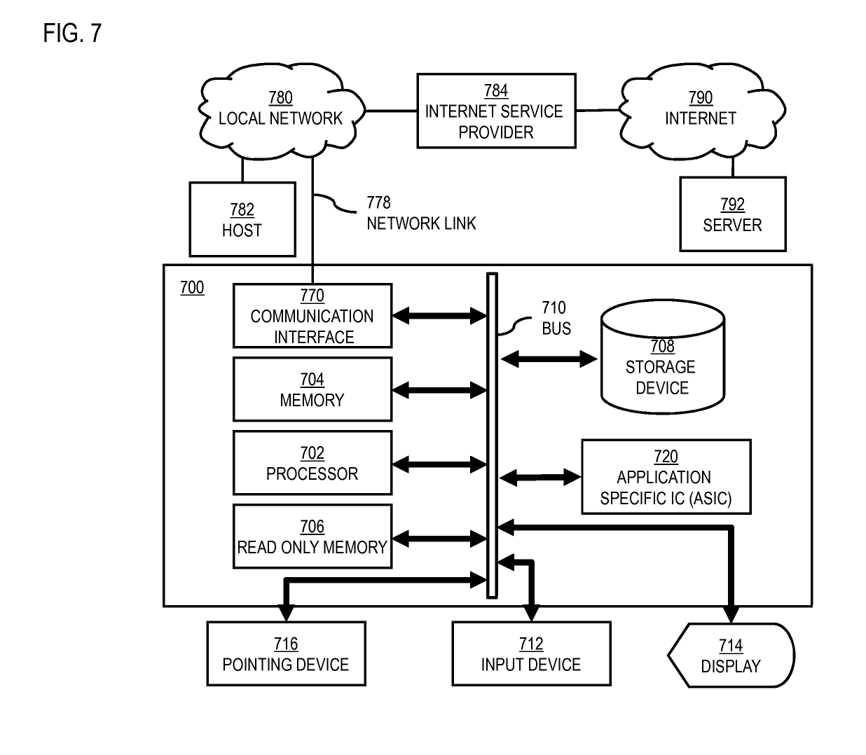

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to support over-the-air provisioning as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of over-the-air provisioning.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to support over-the-air provisioning. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for over-the-air provisioning. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for over-the-air provisioning, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection over the communication network 103 for over-the-air provisioning to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to support over-the-air provisioning as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of over-the-air provisioning.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to support over-the-air provisioning. The memory 805 also stores the data associated with or generated by the execution of the inventive steps.

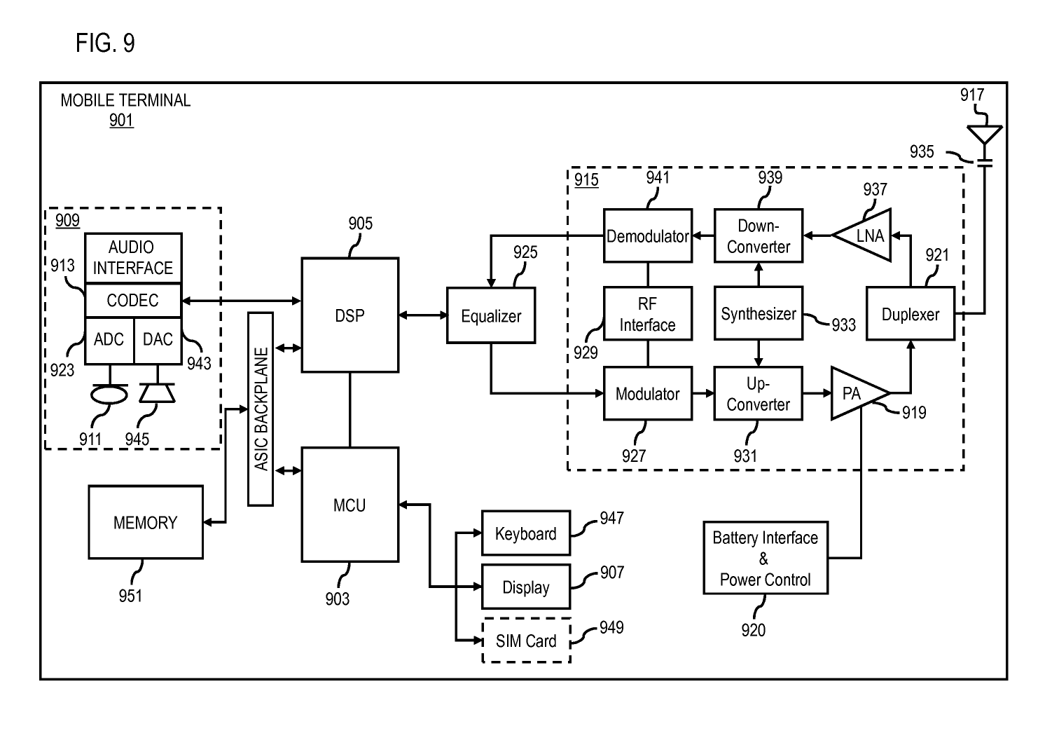

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of over-the-air provisioning. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of over-the-air provisioning. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to support over-the-air provisioning. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a generation of a request to provision one or more services at a device to operate over a data bearer of at least one communication network;
one or more access numbers associated with the one or more services, one or more service providers of the one or more services, or a combination thereof; and
a transmission of the request based, at least in part, on the one or more access numbers,
wherein the one or more access numbers are preconfigured at the device for availability over a plurality of communication networks.

2. A method of claim 1, wherein the (1) data and/or (2) information and/or (3) at least one signal are further based, at least in part, on the following:
one or more configuration messages from the one or more services, the one or more service providers, or a combination thereof, wherein the one or more configuration messages include, at least in part, one or more other access numbers, one or more settings, or a combination thereof associated with the data bearer; and
a provisioning of the one or more services based, at least in part, on the one or more other access numbers, the one or more settings, or a combination thereof.

3. A method of claim 2, wherein the request includes at least one identifier associated with the device, the at least one communication network, or a combination thereof, the method further comprising:
a comparison of the at least one identifier with one or more other identifiers associated with the one or more configuration messages,
wherein the provisioning of the one or more services is further based, at least in part, on the comparison.

4. A method of claim 2, wherein the (1) data and/or (2) information and/or (3) at least one signal are further based, at least in part, on the following:
a caching of the one or more configuration messages at the device,
wherein the cached one or more configuration messages are used for responding to one or more other provisioning requests.

5. A method of claim 1, wherein the (1) data and/or (2) information and/or (3) at least one signal are further based, at least in part, on the following:
a detection of at least one of (a) a first time use of the device, (b) an initialization of the device, (c) an execution of at least one client application of the one or more services, and (d) at least one change in an identifier, an identification module, or the at least one communication network; and
an initiation of the generation of the request based, at least in part, on the detection.

6. A method of claim 1, wherein the data bearer is a text messaging service and the one or more access numbers are one or more text messaging codes.

7. A method comprising facilitating a processing of and/or processing (1) data and/or (2) information and/or (3) at least one signal, the (1) data and/or (2) information and/or (3) at least one signal based, at least in part, on the following:
a request to provision one or more services at a device to operate over a data bearer of at least one communication network, wherein the request is routed based, at least in part, on one or more access numbers associated with the one or more services, one or more service providers of the one or more services, or a combination thereof, and wherein the one or more access numbers are preconfigured at the device for availability over a plurality of communication networks; and
a generation of one or more configuration messages to provision the one or more services, wherein the one or more configuration messages include, at least in part, one or more other access numbers, one or more settings, or a combination thereof associated with the data bearer.

8. A method of claim 7, wherein the (1) data and/or (2) information and/or (3) at least one signal are further based, at least in part, on the following:
at least one determination of the one or more other access numbers, the one or more settings, or a combination thereof based, at least in part, on one or more functions of the one or more services.

9. A method of claim 7, wherein the (1) data and/or (2) information and/or (3) at least one signal are further based, at least in part, on the following:
a processing of the request to determine one or more security tokens; and
an authentication of the request, the device, or a combination thereof based, at least in part, on the one or more security tokens.

10. A method of claim 7, wherein the generation of the one or more configuration messages is based, at least in part, on one or more device management protocols.

11. An apparatus comprising:
at least one processor; and
at least one memory including computer program code for one or more programs,
the at least one memory and the computer program code configured to, with the at least one processor, cause the apparatus to perform at least the following,
cause, at least in part, a generation of a request to provision one or more services at a device to operate over a data bearer of at least one communication network;
determine one or more access number associated with the one or more services, one or more service providers of the one or more services, or a combination thereof; and
cause, at least in part, a transmission of the request based, at least in part, on the one or more access numbers,
wherein the one or more access numbers are preconfigured at the device for availability over a plurality of communication networks.

12. An apparatus of claim 11, wherein the apparatus is further caused to:
receive one or more configuration messages from the one or more services, the one or more service providers, or a combination thereof, wherein the one or more configuration messages include, at least in part, one or more other access numbers, one or more settings, or a combination thereof associated with the data bearer; and
cause, at least in part, a provisioning of the one or more services based, at least in part, on the one or more other access numbers, the one or more settings, or a combination thereof.

13. An apparatus of claim 12, wherein the request includes at least one identifier associated with the device, the at least one communication network, or a combination thereof, the apparatus is further caused to:
cause, at least in part, a comparison of the at least one identifier with one or more other identifiers associated with the one or more configuration messages,
wherein the provisioning of the one or more services is further based, at least in part, on the comparison.

14. An apparatus of claim 12, wherein the apparatus is further caused to:
cause, at least in part, a caching of the one or more configuration messages at the device,
wherein the cached one or more configuration messages are used for responding to one or more other provisioning requests.

15. An apparatus of claim 11, wherein the apparatus is further caused to:
cause, at least in part, a detection of at least one of (a) a first time use of the device, (b) an initialization of the device, (c) an execution of at least one client application of the one or more services, and (d) at least one change in an identifier, an identification module, or the at least one communication network; and
cause, at least in part, an initiation of the generation of the request based, at least in part, on the detection.

16. An apparatus of claim 11, wherein the data bearer is a text messaging service and the one or more access numbers are one or more text messaging codes.

17. An apparatus comprising:
at least one processor; and
at least one memory including computer program code for one or more programs,
the at least one memory and the computer program code configured to, with the at least one processor, cause the apparatus to perform at least the following,
receive a request to provision one or more services at a device to operate over a data bearer of at least one communication network, wherein the request is routed based, at least in part, on one or more access numbers associated with the one or more services, one or more service providers of the one or more services, or a combination thereof, and wherein the one or more access numbers are preconfigured at the device for availability over a plurality of communication networks; and
cause, at least in part, a generation of one or more configuration messages to provision the one or more services, wherein the one or more configuration messages include, at least in part, one or more other access numbers, one or more settings, or a combination thereof associated with the data bearer.

18. An apparatus of claim 17, wherein the apparatus is further caused to:
determine the one or more other access numbers, the one or more settings, or a combination thereof based, at least in part, on one or more functions of the one or more services.

19. An apparatus of claim 17, wherein the apparatus is further caused to:
process and/or facilitate a processing of the request to determine one or more security tokens; and
cause, at least in part, an authentication of the request, the device, or a combination thereof based, at least in part, on the one or more security tokens.

20. An apparatus of claim 17, wherein the generation of the one or more configuration messages is based, at least in part, on one or more device management protocols.
